(19) United States
(12) Patent Application Publication
(10) Pub. No.: US 2014/0326101 A1
(43) Pub. Date: Nov. 6, 2014

(54) CABLE PULLING DEVICE USED IN PARKING MODE MANUALLY RELEASING DEVICE FOR SHIFT-BY-WIRE TYPE AUTOMATIC TRANSMISSION

(71) Applicant: KYUNG CHANG INDUSTRIAL CO., LTD., Daegu (KR)

(72) Inventors: Jonghee Han, Daegu (KR); Hosik Lee, Daegu (KR)

(73) Assignee: KYUNG CHANG INDUSTRIAL CO., LTD., Daegu (KR)

(21) Appl. No.: 13/919,571

(22) Filed: Jun. 17, 2013

(30) Foreign Application Priority Data
May 2, 2013 (KR) 10-2013-0049164

(51) Int. Cl. B60T 7/10; F16C 1/12

(52) U.S. Cl. CPC B60T 7/102; F16C 1/12
USPC 74/502.2

(57) ABSTRACT

Disclosed therein is a cable pulling device used in a parking mode manually releasing device for an shift-by-wire type automatic transmission. The cable pulling device includes: a base; a lever connected rotatably relative to the base, the lever to which a cable is connected; a bar member; and a spring member. The spring member is arranged between the lever and the bar member and is provided to pressurize the bar member toward the base. The cable is pulled by standing up of the lever.

### CROSS-REFERENCE TO RELATED APPLICATION

This application claims priority to Korean Application No. 10-2013-0049164 filed on May 2, 2013, which is incorporated herein by reference.

### TECHNICAL FIELD

The present invention relates to a cable pulling device used in a parking mode manually releasing device for a shift-by-wire type automatic transmission.

### BACKGROUND ART

A shift-by-wire type automatic transmission controls transmission by electrically transferring a control signal of a shift lever mounted in a driver's compartment to an automatic transmission.

The automatic transmission has parking mode. If a vehicle cannot travel due to e.g. traffic accident or if it is difficult to supply electric power due to battery discharge in parking mode, a user or a person can take a measure such as tow only if the parking mode is forcibly released.

A driver pulls a cable of a forcibly parking mode releasing device in order to release the parking mode. Korean Patent Laid-open No. 10-2011-0062879 published on Jun. 10, 2011 discloses the cable pulling device. According to the prior art, the cable is pulled when a gear is turned by an electric motor. However, in order to apply the motor, it is necessary to additionally connect an electric device and a manually releasing device, and hence, the prior art is disadvantageous in space and increases manufacturing costs. Moreover, the prior art has another disadvantage that there is a restriction in the number of operations according to the capacity of a battery.

### SUMMARY

Accordingly, the present invention has been made to solve the above-mentioned problems occurring in the prior arts, and it is an object of the present invention to provide a cable pulling device used in a parking mode manually releasing device for a shift-by-wire type automatic transmission having a simple structure.

To achieve the above objects, the present invention provides a cable pulling device used in a parking mode manually releasing device for an shift-by-wire type automatic transmission, the cable pulling device including: a base; a lever connected rotatably relative to the base, the lever to which a cable is connected; a bar member; and a spring member. The spring member is arranged between the lever and the bar member and is provided to pressurize the bar member toward the base, and the cable is pulled by standing up of the lever relative to the base.

The bar member penetrates the lever and has a stopper arranged inside the lever, and the spring member is arranged between the inner wall of the lever and the stopper.

It is preferable that the cable pulling device further includes a maintaining member adapted for maintaining the lever in a first state that the cable is not pulled.

It is preferable that the base comprises a fixing part for fixing the bar member in a state where the lever stands up and pulls the cable to a tolerance value.

The fixing part is a hole where the bar member is inserted.

The lever includes an over-revolution preventing part for preventing over-revolution of the lever by being locked at an upper portion of the base in the state where the lever stands up and pulls the cable to the tolerance value.

The cable pulling device further includes a strap connected to the bar member. The strap includes a forcedly fitting end portion, and the cable pulling device further includes a joining part to which the forcedly fitting end portion is joined in a snap-in manner.

According to the present invention, the cable pulling device can pull the cable in the simple structure without using an electric motor.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a cable pulling device according to the present invention;

FIG. 2 is an exploded perspective view of the cable pulling device according to the present invention; and

FIG. 3 is a view showing an operational state of the cable pulling device.

### DETAILED DESCRIPTION

Reference will be now made in detail to the preferred embodiment of the present invention with reference to the attached drawings.

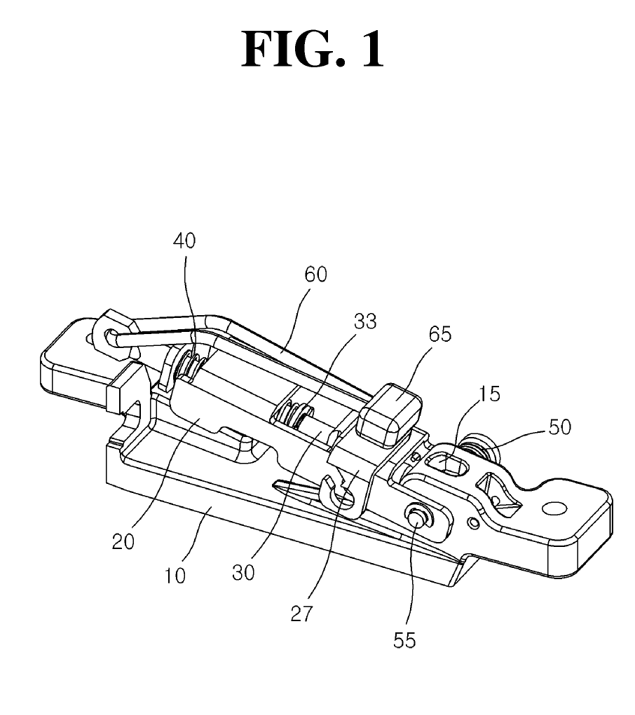

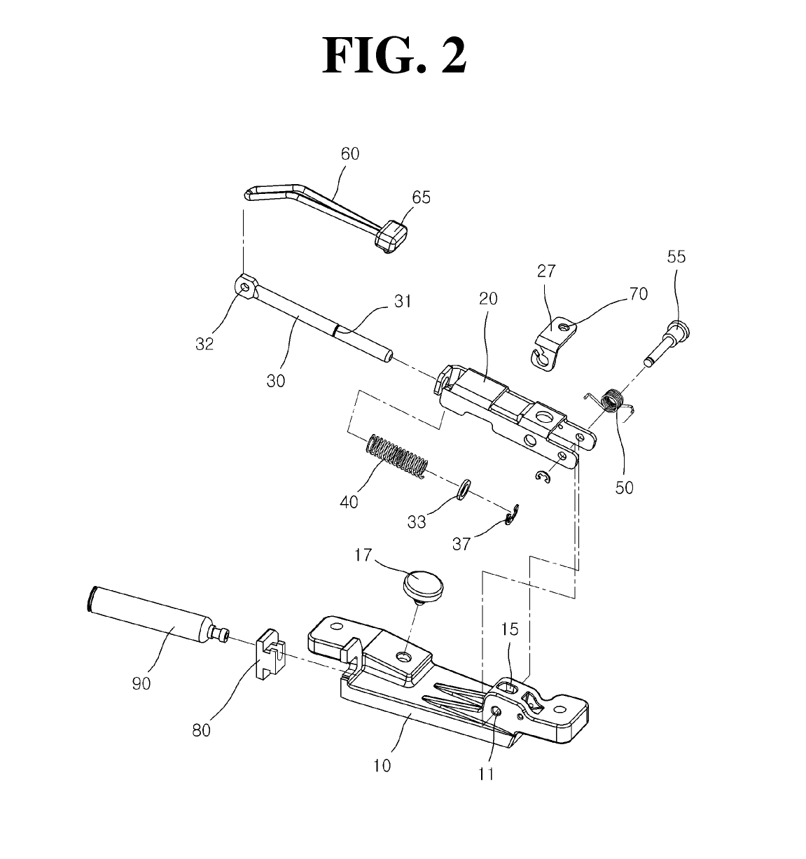

FIG. 1 is a perspective view of a cable pulling device according to the present invention, and FIG. 2 is an exploded perspective view of the cable pulling device according to the present invention.

The cable pulling device according to the present invention includes a base 10, a lever 20 connected rotatably relative to the base 10, a bar member 30, and a spring member 40.

The spring member 40 is arranged between the lever 20 and the bar member 30 to pressurize the bar member 30 toward the base 10. The bar member 30 has a groove 31 formed in the middle of the bar member 30, and a washer 33 is fit in the groove and an E-ring 37 is provided. The washer 33 serves as a stopper, and the spring member 40 is arranged between the lever 20 and the washer 33.

The base 10 is provided with a stopper 17 for preventing further downward movement of the bar member 30.

A cable receiving part 90 for receiving a cable is connected to the base 10 through a clip 80. The cable passing through the cable receiving part 90 is connected one of the bar member 30 and the lever 20 as described later, and is pulled by the bar member 30 and/or the lever 20 which stands up. The base 10 is provided with a fixing part 15, which is formed in a hole.

The lever 20 is rotatably connected to the base 10 by a pin 55, and a return spring 50 is provided to a shaft of the pin 55. The return spring 50 applies pressure on the shaft of the pin 55 so that the lever 20 is returned to the state illustrated in FIG. 1. A cable (not shown) which is connected with the shift control lever is connected to at least one of the lever 20 and the bar member 30, so that the cable is pulled when the lever 20 stands up.

The bar member 30 penetrates the lever 20 has an end portion to which a strap fixing part 32 is provided and the other end portion getting in contact with the base 10, and is in a state where it is pressed toward the base 10 by the spring member 40 arranged between the washer 33 and the lever 20.

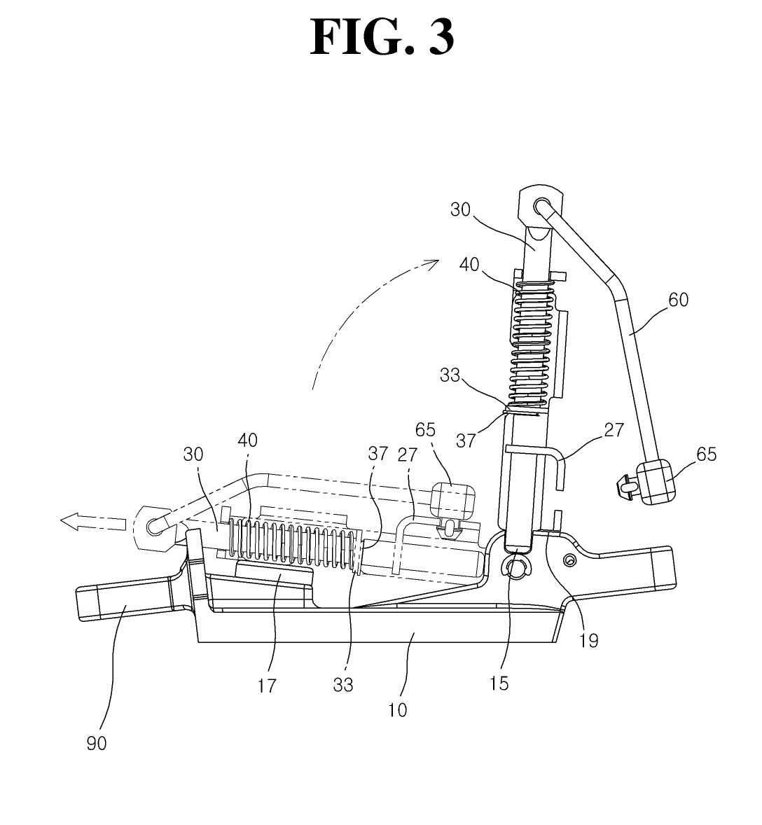

A strap 65 is connected to the strap fixing part 32 of the bar member 30, and a forcedly fitting end portion 65 is provided to an end portion of the strap. The forcedly fitting end portion 65 is joined to a joining part 70 in a snap-in manner. As shown in FIGS. 1 and 2, the joining part 70 may be provided to a separate member 27 (an over-revolution preventing member) which is combined to the lever 20, or to the lever 20. It is preferable that the forcedly fitting end portion 65 of the strap 60 is made of a rubber material which is easy to bind and release in the snap-in manner. As shown in FIG. 3, the snap-in binding means a binding method that a stopper formed on the forcedly fitting end portion 65 is forcedly inserted into a hole.

Next, referring to FIG. 3, the operation of the cable pulling device according to the present invention will be described.

In the state illustrated in FIG. 1, the forcedly fitting end portion 65 of the strap 60 is removed from the joining part 70, and the bar member 30 is pulled in the arrow direction shown in FIG. 3. Next, as shown in FIG. 3, the bar member 30 or the lever 20 stands up by an operator in the clockwise direction. Then, the cable (not shown) is pulled and the pulling power is transferred to the shift control lever (not shown) so as to release the parking mode.

In the erected state, because the bar member 30 is still pressurized toward the base 10 by the spring member 40, the other end portion of the bar member 30 is inserted and fixed into the hole 15 which is the fixing part, and the over-revolution preventing member 27 is locked at an upper portion 19 of the base to thereby prevent additional over-revolution.

In order to return the original state after the manual release of the parking mode is completed, in the erected state illustrated in FIG. 3, the operator pulls the bar member 30 upwardly, removes the other end portion of the bar member 30 from the hole 15, and then, rotates in the counterclockwise direction. The lever 20 is pressurized by the return spring 50 in such a way as to be returned to its original state as shown in FIG. 1, and hence, keeps the original state. Next, the forcedly fitting end portion 65 of the strap 60 is bound to the joining part 70 in the snap-in manner.

While the preferred embodiment of the present invention has been particularly shown with reference to the attached drawings, it will be understood that the scope of the present invention is determined by the following claims and is not limited by the described embodiment and/or drawings. Moreover, it would be understood to those skilled in the art that modifications and equivalents of the present invention belong to the scope of the present invention.

What is claimed is:

1. A cable pulling device used in a parking mode manually releasing device for an shift-by-wire type automatic transmission, the cable pulling device comprising:
a base;
a lever connected rotatably relative to the base, the lever to which a cable is connected;
a bar member; and
a spring member,
wherein the spring member is arranged between the lever and the bar member and is provided to pressurize the bar member toward the base, and
wherein the cable is pulled by standing up of the lever relative to the base.

2. The cable pulling device according to claim 1, further comprising:
a maintaining member adapted for maintaining the lever in a first state that the cable is not pulled.

3. The cable pulling device according to claim 1, wherein the base comprises a fixing part for fixing the bar member in a state where the lever stands up and pulls the cable to a tolerance value.

4. The cable pulling device according to claim 3, wherein the lever comprises an over-revolution preventing part for preventing over-revolution of the lever by being locked at an upper portion of the base in the state where the lever stands up and pulls the cable to the tolerance value.

5. The cable pulling device according to claim 3, wherein the fixing part is a hole where the bar member inserted.

6. The cable pulling device according to claim 5, wherein the lever comprises an over-revolution preventing part for preventing over-revolution of the lever by being locked at an upper portion of the base in the state where the lever stands up and pulls the cable to the tolerance value.

7. The cable pulling device according to claim 1, further comprising a strap connected to the bar member.

8. The cable pulling device according to claim 7, wherein the strap comprises a forcedly fitting end portion, and
wherein the cable pulling device further comprises a joining part to which the forcedly fitting end portion is joined in a snap-in manner.

9. The cable pulling device according to claim 1, wherein the bar member penetrates the lever and has a stopper arranged inside the lever, and
wherein the spring member is arranged between the inner wall of the lever and the stopper.

10. The cable pulling device according to claim 9, further comprising:
a maintaining member adapted for maintaining the lever in a first state that the cable is not pulled.

11. The cable pulling device according to claim 9, wherein the base comprises a fixing part for fixing the bar member in a state where the lever stands up and pulls the cable to a tolerance value.

12. The cable pulling device according to claim 11, wherein the lever comprises an over-revolution preventing part for preventing over-revolution of the lever by being locked at an upper portion of the base in the state where the lever stands up and pulls the cable to the tolerance value.

13. The cable pulling device according to claim 11, wherein the fixing part is a hole where the bar member inserted.

14. The cable pulling device according to claim 13, wherein the lever comprises an over-revolution preventing part for preventing over-revolution of the lever by being locked at an upper portion of the base in the state where the lever stands up and pulls the cable to the tolerance value.

15. The cable pulling device according to claim 9, further comprising a strap connected to the bar member.

16. The cable pulling device according to claim 15, wherein the strap comprises a forcedly fitting end portion, and
wherein the cable pulling device further comprises a joining part to which the forcedly fitting end portion is joined in a snap-in manner.
